(19) United States
(12) Patent Application Publication
(10) Pub. No.: US 2006/0211835 A1
(43) Pub. Date: Sep. 21, 2006

(54) Material which can be hardended by means of actinic radiation, method for the production thereof and use of the same

(76) Inventors: Hubert Baumgart, Munster (DE); Susanne Neumann, Munster (DE); Karl-Heinz Joost, Drensteinfurt (DE); Uwe Meisenburg, Duisburg (DE); Heinz-Peter Rink, Munster (DE); Nicole Stegemann, Senden (DE)

Correspondence Address: BASF CORPORATION, 1609 BIDDLE AVENUE, WYANDOTTE, MI, 48192, US

(21) Appl. No.: 10/543,647

(22) PCT Filed: Jan. 28, 2004
(86) PCT No.: PCT/EP04/00713

§ 371 Date: Mar. 28, 2006

(30) Foreign Application Priority Data
Feb. 12, 2003 (DE) 10305666.1

(51) Int. Cl. C08F 136/00

(52) U.S. Cl. 526/319; 526/335

(57) ABSTRACT

A composition curable with actinic radiation, containing at least one compound (A) selected from the group consisting of p-menthadienes and olefinically unsaturated monomers, processes for preparing it, and the use thereof.

The present invention relates to a novel composition curable with actinic radiation.

The present invention also relates to a novel process for preparing a composition curable with actinic radiation.

The present invention further relates to the use of the novel composition curable with actinic radiation and of the composition prepared by the novel process for producing novel coatings, adhesive films, seals, moldings, and (self-supporting) films.

The present invention relates not least to the novel coatings, adhesive films, seals, moldings, and (self-supporting) films.

The present invention further relates to the novel use of p-menthadienes and olefinically unsaturated monomers of the general formula I
R¹R²C═CR³R⁴ (I)
where the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals, as stabilizers of compositions curable with actinic radiation.

Compositions curable with actinic radiation, especially UV radiation, and their use for producing coatings are known, for example, from German patent DE 197 09 467 C1. The known UV-curable compositions are comparatively stable on storage. They are suitable for use as clearcoat or topcoat materials for producing multicoat paint systems, especially in the automotive sector. A further advantage is that they are solvent-free systems referred to as 100% systems, and so their preparation, application, and curing are accompanied by negligible emissions, if any, of organic compounds.

The coatings produced from these systems possess a high scratch resistance, chemical resistance, moisture resistance, and polishability. Moreover, they feature good weathering stability, good acid/base resistance, and good resistance to bird droppings, a high gloss, and a good appearance.

The stability of the known compositions curable with actinic radiation toward thermal and mechanical loads, however, requires further development in order to satisfy the continually heightened requirements on the part of users. Under adverse conditions, accordingly, there may sometimes be instances of sticking in the application equipment, which can lead in particular to valve malfunction or to clogging of the sensitive nozzles.

Even if the thermal and mechanical loads on the known compositions curable with actinic radiation lead only to slight damage which is not a disruption to application, the resulting coatings may contain gel specks, something which is unacceptable particularly in the context of automotive finishes, where the technological and aesthetic demands are particularly stringent.

Olefinically unsaturated monomers of the general formula I
R¹R²C═CR³R⁴ (I)
where the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals, are known, for example, from German patent application DE 199 30 067 A1. They are used as comonomers for preparing water-dispersible copolymers.

p-Menthadienes occur in nature. They are used, for example, in the paints industry as solvents. For instance, dipentene is miscible with conventional organic solvents and prevents, for example, the skinning of oxidatively curing (air-drying) alkyd resin paints (cf. Römpp Online, 2002, “Limonen”). Depanol®, a mixture of various p-menthadienes, is used for producing oil and alkyd resin paints. It enhances brushability, reduces the skinning tendency considerably, and raises the gloss. Generally speaking it is used up to 20%, based on the solvent fraction (cf. Römpp Online, 2002 “Depanol®”).

alpha-Terpinene can be used as a self-polymerization inhibitor for tetrafluoroethylene.

The use of compounds of the general formula I and of p-menthadienes as stabilizers of compositions curable with actinic radiation is unknown.

It is an object of the present invention to provide a novel composition curable with actinic radiation that no longer has the disadvantages of the prior art but instead is stable on storage in the form of a 100% system and is stable to thermal and mechanical damage, does not give rise to instances of sticking in the application equipment during application, and does not give rise to malfunction or clogging of the valves and sensitive nozzles. Moreover, said composition ought to provide novel, speck-free coatings. Furthermore, the novel composition curable with actinic radiation ought also to be suitable for use as an adhesive and sealant for producing novel adhesive films and seals that are cured with actinic radiation. Not least, it ought also to be suitable for producing novel moldings and (self-supporting) films that are cured with actinic radiation.

The novel coatings produced from the novel composition curable with actinic radiation ought in particular to have a high scratch resistance, chemical resistance, moisture resistance, and polishability. They should also posses good weathering stability, good acid/base resistance, and good resistance to bird droppings, a high gloss, and a good appearance. Not least, they ought to have a particularly smooth surface and be free from specks.

The novel adhesive films produced from the novel composition curable with actinic radiation ought to have a particularly long life and to exhibit particularly high bond strength even under extreme and/or varying climatic conditions.

The novel seals produced from the novel composition curable with actinic radiation ought likewise to be particularly long-lived, to have a particularly high sealing capacity in respect of chemically and physically aggressive media, even under extreme and/or varying climatic conditions, and to be mechanically stable.

The novel moldings and films produced from the novel composition curable with actinic radiation ought likewise to have the advantages depicted above and to be dimensionally stable even under extreme and/or varying climatic conditions.

A further object of the present invention was to provide a novel process for preparing a composition curable with actinic radiation, said process being easy to implement and leading very reproducibly to a composition curable with actinic radiation which should have the advantages described above.

Not least it was an object of the present invention to find a novel use for p-menthadienes and also for olefinically saturated monomers of the general formula I.

The invention accordingly provides the novel composition curable with actinic radiation, containing, based on its total amount, from 0.1 to 5% by weight of at least one compound (A) selected from the group consisting of p-menthadienes and olefinically unsaturated monomers of the general formula I
R¹R²C═CR³R⁴ (I)
where the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals.

The novel composition curable with actinic radiation is referred to below as “composition of the invention”.

The invention further provides the novel process for preparing a composition curable with actinic radiation by mixing of its constituents, using, based on the total amount of the constituents, from 0.1 to 5% by weight of at least one compound (A) selected from the group consisting of p-menthadienes and olefinically unsaturated monomers of the general formula I
R¹R²C═CR³R⁴ (I)
where the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals.

The novel process for preparing a composition curable with actinic radiation is referred to below as “preparation process of the invention”.

The invention not least provides for the novel use of p-menthadienes and of olefinically unsaturated monomers of the general formula I
R¹R²C═CR³R⁴ (I)
where the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals, as stabilizers for compositions curable with actinic radiation, this being referred to below as “use in accordance with the invention”.

The invention further provides for the use of the composition of the invention for producing novel, i.e., inventive, coatings, adhesive films, seals, moldings, and films.

Additional subject matter of the invention will emerge from the description.

In the light of the prior art it was surprising and unforeseeable for the skilled worker that the object on which the present invention was based could be achieved by means of the use in accordance with the invention and by means of the composition of the invention.

In particular it was surprising that the p-menthadienes and the olefinically unsaturated monomers of the general formula I were outstandingly suitable. even in small amounts for use as stabilizers for compositions curable with actinic radiation, especially 100% systems, and stabilize these compositions with respect to thermal and mechanical damage.

Additionally, it was surprising that the composition of the invention was stable on storage as a 100% system and stable toward thermal and mechanical damage, did not result in instances of sticking in the application equipment during application, and did not give rise to malfunction or clogging of the valves and sensitive nozzles. Moreover, it gave speck-free coatings of the invention. Additionally, the composition of the invention was outstandingly suitable for use as an adhesive and sealant for producing adhesive films and seals of the invention. Not least it was also outstandingly suitable for producing novel moldings and films cured with actinic radiation.

The coatings of the invention feature in particular a high scratch resistance, chemical resistance, moisture resistance, and polishability. Moreover, they had good weathering stability, good acid/base resistance, and good resistance to bird droppings, a high gloss, and a good appearance. They featured not least a particularly smooth surface and were free from specks and craters.

The adhesive films of the invention had a particularly long life and a particularly high bond strength even under extreme and/or varying climatic conditions.

The seals of the invention were likewise particularly long-lived, featured a particularly high sealing capacity with respect to chemically and physically aggressive media, even under extreme and/or varying climatic conditions, and were particularly stable mechanically.

The moldings and films of the invention likewise had the advantages depicted above and were dimensionally stable even under extreme and/or varying climatic conditions.

The preparation process of the present invention was easy to implement and gave, very reproducibly, the composition of the invention having the advantages described above.

The composition of the invention comprises at least one compound (A) selected from the group consisting of the p-menthadienes. Additionally or alternatively thereto the composition of the invention comprises at least one compound (A) selected from the group consisting of the olefinically unsaturated monomers of the general formula I.

The p-menthadienes (A) are preferably selected from the group consisting of the naturally occurring p-menthadienes. With particular preference they are selected from the group consisting of alpha-, beta-, and gamma-terpinene, terpinolene, (+)-(S)-alpha-phellandrene, (−)-(R)-alpha-phellandrene, (+)-(S)-beta-phellandrene, (−)-(R)-beta-phellandrene, (+)-(R)-limo-nene, (−)-(S)-limonene, and (±)-limonene (dipentene) Use is made in particular of gamma-terpinene.

In the general formula I the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals.

Examples of suitable alkyl radicals include methyl, ethyl, propyl, isopropyl, n-butyl, isobutyl, tert-butyl, amyl, hexyl, and 2-ethylhexyl.

Examples of suitable cycloalkyl radicals include cyclobutyl, cyclopentyl, and cyclohexyl.

Examples of suitable alkylcycloalkyl radicals include methylenecyclohexane, ethylenecyclohexane, and propane-1,3-diylcyclohexane.

Examples of suitable cycloalkylalkyl radicals include 2-, 3-, and 4-methyl-, -ethyl-, -propyl-, and -butylcyclohex-1-yl.

Examples of suitable aryl radicals include phenyl, naphthyl, and biphenylyl, preferably phenyl and naphthyl, and especially phenyl.

Examples of suitable alkylaryl radicals include benzyl and ethylene- or propane-1,3-diylbenzene.

Examples of suitable cycloalkylaryl radicals include 2-, 3-, and 4-phenylcyclohex-1-yl.

Examples of suitable arylalkyl radicals include 2-, 3-, and 4-methyl-, -ethyl-, -propyl-, and -butylphen-1-yl.

Examples of suitable arylcycloalkyl radicals include 2-, 3-, and 4-cyclohexylphen-1-yl.

The above-described radicals R¹, R², R³, and R⁴ may be substituted. For this purpose use may be made of electron-donating or electron-withdrawing atoms or organic radicals.

Examples of suitable substituents are halogen atoms, especially chlorine and fluorine, nitrile groups, nitro groups, partly or fully halogenated, especially chlorinated and/or fluorinated, alkyl, cycloalkyl, alkylcycloalkyl, cycloalkylalkyl, aryl, alkylaryl, cycloalkylaryl, arylalkyl, and arylcycloalkyl radicals, including those exemplified above, especially tert-butyl; aryloxy, alkyloxy, and cycloalkyloxy radicals, especially phenoxy, naphthoxy, methoxy, ethoxy, propoxy, butyloxy or cyclohexyloxy; arylthio, alkylthio, and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

Examples of monomers of the general formula I used with particular preference in accordance with the invention include 1,1-diphenylethylene, 1,1-dinaphthalene-ethylene, cis- and trans-stilbene, vinylidenebis-(4-N,N-dimethylaminobenezene), vinylidenebis(4-amino-benzene), and vinylidenebis(4-nitrobenzene).

In accordance with the invention compound (A) is used in an amount of from 0.1 to 5%, preferably from 0.1 to 4%, and in particular from 0.1 to 3% by weight, based in each case on the total amount of the composition of the invention.

The composition of the invention is preferably a liquid or solid 100% system.

The solid 100% system is preferably a powder coating material with a conventional average particle size and particle size distribution. The average particle size is preferably from 10 to 90 μm, the fraction of particles sized <10 μm is preferably <10% by weight, the fraction of particles sized >100 μm is preferably <1% by weight. With particular preference the particle size distribution is narrow.

With particular preference the composition of the invention is a liquid 100% system.

Essential to the composition of the invention as a 100% system is that it includes substantially smaller amounts of organic solvents than the customary and known conventional—i.e., solvent-containing—compositions curable with actinic radiation.

The composition of the invention is curable with actinic radiation. In addition it may also be thermally curable, and is then referred to by those in the art as a dual-cure composition.

Suitable actinic radiation includes electromagnetic radiation and corpuscular radiation. The electromagnetic radiation embraces near infrared (NIR), visible light, UV radiation, X-rays, and gamma radiation, especially UV radiation. The corpuscular radiation embraces electron beams, alpha radiation, proton beams, and neutron beams, especially electron beams.

Apart from the compound (A) for inventive use there is nothing critical about the physical makeup of the composition of the invention, which is instead based on the conventional compositions curable with actinic radiation, especially 100% systems. This underlines a further particular advantage of the use in accordance with the invention, namely that it is not restricted to a narrow class of compositions curable with actinic radiation but instead can be employed over an extremely broad spectrum.

Accordingly, the composition of the invention may comprise all conventional constituents of compositions curable with actinic radiation, such as radiation-curable binders, radiation-curable reactive diluents, and photoinitiators. It may further comprise conventional auxiliaries and additives, such as light stabilizers, adhesion promoters (tackifiers), slip additives, leveling agents, polymerization inhibitors, flatting agents, nanoparticles, and film-forming auxiliaries.

Examples of suitable compositions curable with actinic radiation that are suitable as a basis for the composition of the invention include, for example, those known from German patent DE 197 09 467 C1, page 4 line 30 to page 6 line 30, or from German patent application DE 199 47 523 A1.

If the composition of the invention is also curable thermally, i.e., is a dual-cure composition, it preferably further comprises conventional thermosetting binders and crosslinking agents and/or thermosetting reactive diluents, as is described, for example, in German patent applications DE 198 18 735 A1 and DE 199 20 799 A1 or in European patent application EP 0 928 800 A1.

The preparation of the composition of the invention takes place preferably by the preparation process of the invention, by mixing of the above-described constituents in suitable mixing equipment such as stirred tanks, stirrer mills, extruders, compounders, Ultraturrax machines, inline dissolvers, static mixers, micromixers, toothed-wheel dispersers, pressure release nozzles and/or microfluidizers. It is preferred here to operate in the absence of light with a wavelength λ<550 nm or in complete absence of light, in order to prevent premature crosslinking of the composition of the invention.

The composition of the invention serves to produce compositions cured with actinic radiation, especially coatings, paint systems, moldings, and self-supporting films.

To produce the moldings and films of the invention the composition of the invention is applied to conventional temporary or permanent substrates. For producing the films and moldings of the invention it is preferred to use conventional temporary substrates, such as metallic and polymeric belts or hollow bodies made of metal, glass, plastic, wood or ceramic, which can easily be removed without damaging the films and moldings of the invention.

Where the composition of the invention is used for producing coatings, adhesive films, and seals, permanent substrates are used, such as motor vehicle bodies and parts thereof, the interior and exterior of buildings and parts thereof, doors, windows, furniture, hollow glassware, coils, freight containers, packaging, small industrial parts, optical components, electrical components, mechanical components, and components for white goods. The films and moldings of the invention may likewise serve as substrates.

In terms of method the application of the liquid composition of the invention has no special features but may instead take place by any conventional application method, such as squirting, spraying, knife coating, brushing, flow coating, dipping, trickling or rolling, for example.

Application of the pulverulent composition of the invention likewise has no peculiarities as far as method is concerned but instead takes place, for example, in accordance with the conventional fluid-bed methods, such as are known, for example, from the BASF Coatings AG brochures, “Pulverlacke für industrielle Anwendungen”, January 2000, or “Coatings Partner, Pulverlack Spezial”, January 2000, or Römpp Lexikon Lacke und Druckfarben, Georg Thieme Verlag, Stuttgart, New York, 1998, pages 187 and 188, “electrostatic powder spraying”, “electrostatic spraying”, and “electrostatic fluidized-bath process”.

During application it is advisable to operate in the absence of actinic radiation, in order to prevent premature crosslinking of the composition of the invention.

The applied composition of the invention is preferably cured with UV radiation. During irradiation it is preferred to use a radiation dose of from 100 to 6000, more preferably from 200 to 3000, more preferably still from 300 to 1500, and with particular preference from 500 to 1200 mJ cm⁻², the region <1200 mJ cm⁻² being especially preferred.

The intensity of radiation may vary greatly. It is guided in particular by the radiation dose on the one hand and by the radiation time on the other. For a given radiation dose, the irradiation time is governed by the belt speed or speed of advance of the substrates in the irradiation unit, and vice versa. The radiation intensity is preferably from 1×10⁰ to 3×10⁵, more preferably from 2×10⁰ to 2×10⁵, very preferably from 3×10⁰ to 1.5×10⁵, and in particular from 5×10⁰ to 1.2×10⁵ W m⁻².

Radiation sources which can be used for the UV radiation include all conventional UV lamps. Flash lamps are likewise suitable, but are less preferred in accordance with the invention. As UV lamps it is preferred to use mercury vapor lamps, more preferably low, medium, and high pressure mercury vapor lamps, particularly medium pressure mercury vapor lamps. Particular preference is given to using unmodified mercury vapor lamps together with appropriate filters, or else mercury vapor lamps which have been modified, in particular by doping.

Preference is given to using gallium-doped and/or iron-doped, especially iron-doped, mercury vapor lamps, as described, for example, in R. Stephen Davidson, “Exploring the Science, Technology and Applications of U.V. and E.B. Curing”, Sita Technology Ltd., London, 1999, Chapter I, “An Overview”, page 16, FIG. 10, or Dipl.-Ing. Peter Klamann, “eltosch System-Kompetenz, UV-Technik, Leitfaden fur Anwender”, page 2, October 1998.

Examples of suitable flash lamps are those from the company VISIT.

The distance of the UV lamps from the applied composition of the invention may vary surprisingly widely and may therefore be adapted very effectively to the requirements of the case in hand. The distance is preferably from 2 to 200 cm, more preferably from 5 to 100 cm, very preferably from 10 to 50 cm, and in particular from 15 to 30 cm. Lamp arrangement can also be adapted to the circumstances of the substrate and the process parameters. In the case of substrates of complex shape, as are envisaged for automobile bodies, those regions not accessible to direct radiation (shadow regions), such as cavities, folds, and other structural undercuts, may be cured using pointwise, small-area or all-round sources, together with an automatic movement means for the irradiation of cavities or edges.

Irradiation can be carried out under an oxygen-depleted atmosphere. “Oxygen-depleted” means that the oxygen content of the atmosphere is lower than that of air (20.95% by volume). In principle the atmosphere may even be oxygen-free, in which case it is an inert gas.

Owing to the absence of the inhibiting effect of oxygen, however, this may result in sharp acceleration of the radiation cure, possibly leading to inhomogeneities and stresses in the cured compositions of the invention. It is therefore beneficial not to reduce the oxygen content of the atmosphere to a volume percentage of zero.

In the case of the applied dual-cure composition of the invention the thermal cure may take place with the aid for example of a gaseous, liquid and/or solid, hot medium, such as hot air, heated oil or heated rollers, or of microwave radiation, infrared light and/or near infrared (NIR) light. Heating preferably takes place in a forced-air oven or by irradiation using IR and/or NIR lamps. As in the case of the actinic radiation cure, the thermal cure may also take place in stages. The thermal cure is effected advantageously at temperatures from room temperature up to 200° C.

Both the thermal cure and the actinic radiation cure can be carried out in stages. Such stages may take place one after another (sequentially) or simultaneously. In accordance with the invention, sequential curing is of advantage and is therefore used with preference. It is particularly advantageous in this case to carry out the thermal cure after the actinic radiation cure.

The resultant films, moldings, coatings, adhesive films, and seals of the invention are outstandingly suitable for the coating, adhesive bonding, sealing, wrapping, and packaging of motor vehicle bodies and parts thereof, the interior and exterior of buildings and parts thereof, doors, windows, furniture, hollow glassware, coils, freight containers, packaging, small industrial parts, such as nuts, bolts, wheel rims or hub caps, electrical components, such as windings (coils, stators, rotors), optical components, mechanical components, and components for white goods, such as radiators, household appliances, refrigerator casings, and washing machine casings.

In particular, however, the composition of the invention is used as a coating material, preferably as a topcoat or clearcoat material, particularly as a clearcoat material for producing multicoat color and/or effect, electrically conductive, magnetically shielding or fluorescent paint systems, especially multicoat color and/or effect paint systems. For producing the multicoat paint systems it is possible to employ conventional wet-on-wet techniques and coating system architectures.

The resultant clearcoats of the invention are the outermost coats of the multicoat paint systems, which substantially determine the overall appearance and protect the color and/or effect coats against mechanical, chemical, and radiation-induced damage. Consequently, deficiencies in the hardness, scratch resistance, chemical resistance, and yellowing stability of the clearcoat are also manifested to a particularly severe extent. The clearcoats of the invention, however, exhibit little yellowing. They are highly scratch-resistant and show only very small losses of gloss after scratching. At the same time they are possessed of a high hardness. Not least, they enjoy a particularly high chemical resistance, and adhere very firmly to the color and/or effect coats.

The substrates of the invention coated with coatings of the invention, adhesively bonded with adhesive films of the invention, sealed with seals of the invention and/or wrapped or packaged with films and/or moldings of the invention therefore have outstanding long-term service properties and a particularly long service life.

### INVENTIVE AND COMPARATIVE EXAMPLES

### Examples 1 to 3 (Inventive) and C1 (Comparative)

### The Preparation of UV-Curable Clearcoat Materials

The clearcoat materials of Examples 1 to 3 and C1 were prepared by mixing the constituents indicated in the table and homogenizing the resultant mixtures. These operations were carried out in the absence of visible light.

The stability of the clearcoat materials to thermal and mechanical loads was determined by measuring the onset temperature of the polymerization by means of differential thermoanalysis (differential scanning calorimetry, DSC) and the greased valve index. Their curing properties were determined on the basis of the vertical reactivity.

For determining the greased valve index the closing mechanisms of greased ball valves were wetted with the clearcoat materials. The ball valves were subsequently opened and closed until the clearcoat materials had undergone crosslinking and so had immobilized the valves. The number of opening and closing operations in each case was counted and converted to a rating:

| Rating | Number of opening and closing operations |
|---|---|
| 1 | ≦10 |
| 2 | 11-25 |
| 3 | 26-50 |
| 4 | 51-100 |
| 5 | >100 |

To determine the vertical reactivity, the clearcoat materials were applied in a film thickness of 40 μm to metal panels. The panels were placed upright in black boxes and in this setup were irradiated from above with UV radiation. Familiarly to those skilled in the art, this resulted in a reduction in the degree of curing of the clearcoat materials from top to bottom. The reactivity of the clearcoat materials was in accordance with specification when they had undergone full cure over an area extending from the top edge of the panels down by a vertical distance of at least 70 mm. The results of the experiments can likewise be found in the table.

TABLE 1
Physical composition of the clearcoat materials of
Examples 1 to 3 and C1, and their stability

| | Examples: | | | |
|---|---|---|---|---|
| Constituent | 1 | 2 | 3 | C1 |
| Dipentaerythritol pentaacrylate | 34.95 | 34.6 | 34.6 | 35.3 |
| Tricyclodecanedimethanol | 55.38 | 54.8 | 54.8 | 55.94 |
| diacrylate | | | | |
| Styrene-free unsaturated | 4.8 | 4.75 | 4.75 | 4.86 |
| polyester resin (80% in xylene, | | | | |
| adhesion promoter, Degussa/Huls) | | | | |
| Polysiloxane with terminal | 0.7 | 0.7 | 0.7 | 0.7 |
| olefinically unsaturated groups | | | | |
| (reactive leveling, slip, and | | | | |
| antiblocking agent) | | | | |
| Polyether-modified | 0.2 | 0.2 | 0.2 | 0.2 |
| polydimethylsiloxane | | | | |
| Hydroxycyclohexyl phenyl ketone | 2.97 | 2.95 | 2.95 | 3 |
| 1,1-Diphenylethane | 1 | — | 2 | — |
| gamma-Terpinene | — | 2 | — | — |
| Onset temperature (° C.) | 145 | 140 | 158 | 129 |
| Greased valve index | 5 | 5 | 5 | 1 |
| Vertical reactivity (mm) | 95 | 107 | 78 | >70 |

A comparison of the results shows that the clearcoat materials of Examples 1 to 3 were significantly more stable to thermal and mechanical loads than the clearcoat material of Example Cl. Surprisingly, the vertical activity of the clearcoat materials of Examples 1 to 3 corresponded to that of the clearcoat material of Example C1. Accordingly, the clearcoat materials of Examples 1 to 3 could be applied at higher temperatures and hence, advantageously, lower viscosities than the clearcoat material of Example C1.

The clearcoat materials of Examples 1 to 3 and of Example C1 otherwise have the same advantageous performance properties, and gave clearcoats possessing in particular a high scratch resistance, chemical resistance, moisture resistance, and polishability. Moreover, they had a good weathering stability, good acid/base resistance, and good resistance to bird droppings, a high gloss, and good appearance. Not least, they had a particularly smooth surface and were free from specks and craters.

1. A composition curable with actinic radiation, containing, based on its total amount, from 0.1 to 5% by weight of at least one compound (A) selected from the group consisting of p-menthadienes and olefinically unsaturated monomers of the general formula I
R¹R²C═CR³R⁴ (I)
where the radicals R¹, R², R³, and R⁴ each independently are hydrogen atoms or substituted or unsubstituted radicals selected from the group consisting of alkyl, cycloalkyl, alkylcycloalkyl, cycloalkylalkyl, aryl, alkylaryl, cycloalkylaryl, arylalkyl and arylcycloalkyl radicals, with the proviso that at least two of R¹, R², R³, and R⁴ are substituted or unsubstituted aryl, arylalkyl or arylcycloalkyl radicals.

2. The composition as claimed in claim 1, which is a liquid or solid 100% solvent free system.

3. The composition as claimed in claim 1, which is curable with at least one of electromagnetic radiation and corpuscular radiation.

4. The composition as claimed in claim 3, wherein the electromagnetic radiation embraces near infrared (NIR), visible light, UV radiation, X-rays, and gamma radiation and the corpuscular radiation embraces electron beams.

5. The composition as claimed in claim 4, wherein the electromagnetic radiation is UV radiation.

6. The composition as claimed in claim 1, containing, based on its total amount, from 0.1 to 2% by weight of at least one compound (A).

7. The composition as claimed in claim 1, wherein the p-menthadienes (A) are selected from the group consisting of the naturally occurring p-menthadienes.

8. The composition as claimed in claim 7, wherein the p-menthadienes (A) are selected from the group consisting of alpha-, beta-, and gamma-terpinene, terpinolene, (+)-(S)-alpha-phellandrene, (−)-(R)-alpha-phellandrene, (+)-(S)-beta-phellandrene, (−)-(R)-beta-phellandrene, (+)-(R)-limonene, (−)-(S)-limonene, and (±)-limonene (dipentene).

9. The composition as claimed in claim 8, comprising gamma-terpinene.

10. The composition as claimed in claim 1, wherein the aryl radicals R¹, R², R³ or R⁴ of the compound (A) of the general formula I are phenyl or naphthyl radicals, especially phenyl radicals.

11. The composition as claimed in claim 1, wherein the substituents in the radicals R¹, R², R³ or R⁴ of the compound (A) of the general formula I are selected from the group consisting of electron-donating atoms, electron-withdrawing atoms, organic radicals, selected from the group consisting of halogen atoms, nitrile, nitro, partially hydrogenated, and fully halogenated alkyl, cycloalkyl, alkylcycloalkyl, cycloalkylalkyl, aryl, alkylaryl, cycloalkylaryl, arylalkyl, and arylcycloalkyl radicals; aryloxy, alkyloxy, cycloalkyloxy radicals; arylthio, alkylthio, cycloalkylthio radicals; hydroxyl groups, primary amino, secondary amino and tertiary amino groups.

12. A process for preparing a composition curable with actinic radiation as claimed claim 1 comprising mixing constituents comprising from 0.1 to 5% by weight of at least one compound (A) selected from the group consisting of p-menthadienes and olefinically unsaturated monomers of the general formula I
R¹R²C═CR³R⁴ (I)
where the radicals R¹, R², R³, and R⁴ each independently are hydrogen atoms or radicals selected from the group consisting of substituted and unsubstituted alkyl, cycloalkyl, alkylcycloalkyl, cycloalkylalkyl, aryl, alkylaryl, cycloalkylaryl, arylalkyl and arylcycloalkyl radicals, with the proviso that at least two of the variables R¹, R², R³, and R⁴ are substituted or unsubstituted aryl, arylalkyl or arylcycloalkyl radicals.

13. Compositions cured with actinic radiation comprising comprising a composition as claimed in claim 1.

14. Compositions as claimed in claim 13 comprising a component of a protective coating which is at least one of coatings, paint systems, moldings, and self-supporting films.

15. (canceled)

16. A substrate having thereon a protective coating according to claim 14 comprising at least one of motor vehicles and parts thereof, buildings, furniture, windows, doors, small industrial parts, coils, freight containers, packaging, white goods, films, optical components, electrical components, mechanical components, components for white goods, and hollow glassware.

17. A process for producing a composition cured with actinic radiation from a composition curable with actinic radiation by radiation curing, which comprises using a composition as claimed claim 1.

18. A stabilizer for compositions curable with actinic radiation comprising a compound selected from the group consisting of p-menthadienes and olefinically unsaturated monomers of the general formula I
R¹R²C═CR³R⁴ (I)
where the radicals R¹, R², R³, and R⁴ each independently are hydrogen atoms or radicals selected from the group consisting of substituted and unsubstituted alkyl, cycloalkyl, alkylcycloalkyl, cycloalkylalkyl, aryl, alkylaryl, cycloalkylaryl, arylalkyl and arylcycloalkyl radicals, with the proviso that at least two of the variables R¹, R², R³, and R⁴ are substituted or unsubstituted aryl, arylalkyl or arylcycloalkyl radicals.
